(19) United States
(12) Patent Application Publication
(10) Pub. No.: US 2026/0245329 A1
(43) Pub. Date: Aug. 20, 2026

(54) IMAGE ANALYSIS SYSTEM

(71) Applicant: HITACHI KOKUSAI ELECTRIC INC., Tokyo (JP)

(72) Inventors: Yusuke OBONAI, Tokyo (JP); Keigo HASEGAWA, Tokyo (JP)

(21) Appl. No.: 19/159,808

(22) PCT Filed: Feb. 27, 2023
(86) PCT No.: PCT/JP2023/007063

§ 371 Date: Aug. 26, 2025

(51) Int. Cl. G06V 10/25; G06V 10/776; G06V 10/94

(52) U.S. Cl. CPC G06V 10/25; G06V 10/776; G06V 10/95

(57) ABSTRACT

An image analysis system is provided for detecting an object from an input image by inference using an AI model. The system comprises an analysis server comprising: a function for acquiring a first conversion image by performing a first image conversion on the input image; a function for acquiring a second conversion image by performing a second image conversion different from the first image conversion on the input image; a function for acquiring a first inference result by providing the input image or the first conversion image to the AI model; a function for acquiring a second inference result by providing the second conversion image to the AI model; a function for integrating the second inference result with the first inference result; and a function for calculating a difficulty in detecting the object from the input image or the first conversion image to compare with a first threshold.

### TECHNICAL FIELD

The present disclosure relates to an image analysis system that performs object detection processing for detecting a specific object from an input image using an AI model.

### BACKGROUND

Artificial intelligence (AI) such as deep learning (DL) is being increasingly applied to tasks for performing object detection and attribute identification using still images or videos. By incorporating AI functions into products and systems, human work such as monitoring can be replaced by computers. As a result, it is possible to reduce labor costs and enhance the added value of products, which are considered to greatly contribute to the sales promotion of products and systems. Therefore, many companies are highly interested in AI.

A well-known object detection method using DL includes a method that uses a neural network type AI model to infer the type and position of an object included in an input image. Generally, supervised learning is used to train AI models. In other words, an AI model that solves the problem of outputting a correct output signal from an input image is trained using a pair of an input image for a certain problem and an output signal expected as a result of inputting the image. The pair of the input image and the expected output is referred to as training data.

In practical use, an AI model requires generalization performance that can correctly infer the type and position of an object even for unknown input data. For example, in the case of a system that detects intruders into outdoor public infrastructure facilities based on camera images, the imaging environment may be different from that at the time of collecting the input data for training due to differences in weather and time of day, which causes a decrease in the inference accuracy. Therefore, it is generally desirable to acquire training data in various environments to enhance the diversity of training data.

However, when training a general-purpose AI model using diverse training data, a huge amount of calculation is required to extract and analyze many features, and a high-performance computer is also required during operation. However, in some cases, a high-performance computer cannot be available due to restrictions on the space, the power consumption of the application target of the AI model, or the like. Therefore, an AI model with a low amount of calculation has to be used. As a result, when the untrained data occurs in the operating environment, the inference accuracy deteriorates. Here, the unlearned data/unseen data refers to data in which the lighting conditions are different from those at the time of training due to factors such as the time of day and season, or data acquired at an imaging location that is not included during training.

As a method for suppressing the deterioration in the inference accuracy, the adjustment of detection parameters for determining detection/non-detection, or the preprocessing performed by image conversion such as left-right inversion/horizontal flipping are mainly performed. Generally, in object detection tasks, certainty/confidence score is often used to determine detection/non-detection. The certainty is a statistical measure that indicates a degree of accuracy of the inference result acquired by the AI model. For example, if the certainty is 60% or more, it is determined to be detection, and if it is less than 60%, it is determined to be non-detection. In this manner, the certainty is compared with a predetermined certainty threshold to determine detection/non-detection. Since, however, the optimal detection parameters vary depending on the imaging conditions such as time of day, season, and a detection target, it has been necessary for a specialized engineer to adjust the detection parameters appropriately in order to suppress the decrease in the inference accuracy.

The improvement of the inference accuracy by performing the left-right inversion as the image conversion on the input image is reported in Non-Patent Document 1. However, in Non-Patent Document 1, both the original image and the inverted/flipped images are inferred simultaneously, so that the processing speed decreases. In addition, similarly to the detection parameters, the optimal image conversion/transformation method varies depending on the imaging conditions, so that a specialized engineer needs to appropriately select the image conversion method in order to prevent the decrease in the inference accuracy.

### PRIOR ART DOCUMENTS

### Patent Documents

Non-patent Document 1: B. Cheng et. al., “HigherHRNet: Scale-Aware Representation Learning for Bottom-Up Person Pose Estimation”, arXiv: 1908.10 357v3, Mar. 12, 2020
Non-patent Document 2: D. Yoo et. al., “Learning Loss for Active Learning”, arXiv: 1905.03677, May 9, 2019

### SUMMARY

### Problems to Be Resolved by the Invention

The present disclosure has been made in consideration of the above-described conventional circumstances, and it is an object of the present disclosure to provide a mechanism that can efficiently address the deterioration of the inference accuracy in object detection using an AI model.

### Means for Solving the Problems

In order to achieve the above-described object, the image analysis system according to one aspect of the present disclosure can be configured as follows.

That is, in an image analysis system for detecting a predetermined object from an input image by inference using an AI model, the image analysis system comprises: a function for acquiring a first conversion image by performing a first image conversion, which is set as preprocessing, on the input image; a function for acquiring a second conversion image by performing a second image conversion, which is different from the first image conversion, on the input image; a function for acquiring a first inference result by providing the input image or the first conversion image to the AI model; a function for acquiring a second inference result by providing the second conversion image to the AI model; and a function for integrating the second inference result with the first inference result.

In the image analysis system according to the present disclosure, a difficulty in detecting the object from the input image or the first image is calculated and compared with a first threshold, and if the difficulty is equal to or greater than the first threshold, a series of processes for acquiring the second conversion image by performing the second image conversion on the input image, acquiring the second inference result by providing the second conversion image to the AI model, and integrating the second inference result with the first inference result are performed, and otherwise, the series of processes are not performed.

In the image analysis system according to the present disclosure, the second image conversion includes multiple types of image conversion, and an image conversion corresponding to an inference result that provides a best result among a plurality of inference results respectively corresponding to the multiple types of image conversion is set as preprocessing for subsequent processes.

In the image analysis system according to the present disclosure, the inference result includes a candidate region of the object in the image provided to the AI model, and whether or not to integrate the second inference result with the first inference result is determined based on a degree of overlap between a candidate region of the object in the first inference result and a candidate region of the object in the second inference result.

In the image analysis system according to the present disclosure, the second image conversion includes multiple types of image conversion, the inference result includes a candidate region of the object in the image provided to the AI model, and whether or not to integrate the second inference result with the first inference result is determined based on a degree of overlap between a candidate regions of the object in multiple inference results respectively corresponding to the multiple types of image conversion.

### Effect of the Invention

In accordance with the present disclosure, the mechanism capable of efficiently dealing with the decrease in the inference accuracy in the object detection using the AI model can be provided.

### BRIEF DESCRIPTION OF THE DRAWINGS

FIG. 1 is a diagram showing a configuration example of a monitoring system according to an embodiment of the present disclosure.

FIG. 2 is a diagram showing a configuration example of an analysis server in the monitoring system shown in FIG. 1.

FIG. 3 is a diagram showing a configuration example of an inference result reflection part in the analysis server shown in FIG. 2.

FIG. 4 is a diagram explaining an overview of comparison of image conversion methods.

FIG. 5 is a diagram explaining comparison of image conversion methods using IoU.

FIG. 6 is a diagram explaining the evaluation of the detection difficulty using a detection difficulty evaluation AI model.

FIG. 7 is a diagram explaining the overall flow of the operation of the monitoring system shown in FIG. 1.

FIG. 8 is a diagram explaining a detection object determination method using both IoU between regions and a detection difficulty evaluation AI model in combination.

FIG. 9 is a diagram explaining the addition of training data to an object detection AI model due to the addition of a new detection object.

FIG. 10 is a diagram showing an example of the processing flow of the monitoring system shown in FIG. 1.

### DETAILED DESCRIPTION

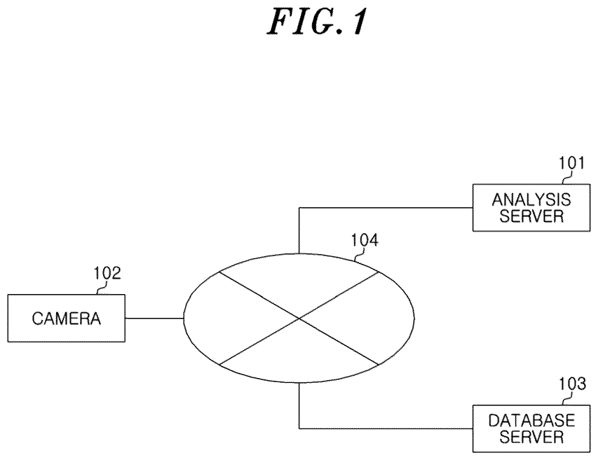

An embodiment of the present disclosure will be described with reference to the accompanying drawings. FIG. 1 shows a configuration example of a monitoring system including an image analysis system of the present disclosure. The monitoring system of the present embodiment includes, as main components, an analysis server 101, a camera 102, and a database server 103. They are connected to each other via a network 104 so that they can communicate with each other.

The analysis server 101 includes an electronic computer system including hardware such as a central processing unit (CPU), a memory, or the like. The analysis server 101 may further include other processors such as a digital signal processor (DSP), a field-programmable gate array (FPGA), a graphics processing unit (GPU), and the like. The analysis server 101 is configured to realize each function of the image analysis system of the present disclosure by loading a predetermined program into the memory and executing it with the processor such as the CPU or the like, for example.

The network 104 is a line that is capable of data communication and connects the devices (such as the analysis server 101, the camera 102, the database server 103, and the like) constituting the monitoring system. The network 104 can be realized using a dedicated line, an intranet, an IP network including the Internet, or the like, and the type of the line is not particularly limited.

The camera 102 transmits an image acquired by imaging a monitoring region to the analysis server 101 via the network 104. The analysis server 101 analyzes the image received from the camera 102, and transmits data including the results to the database server 103 to be stored therein. The system configuration shown in FIG. 1 is an example, and various modifications can be made. For example, the camera 102 itself may have the functions of the image analysis system of the present disclosure.

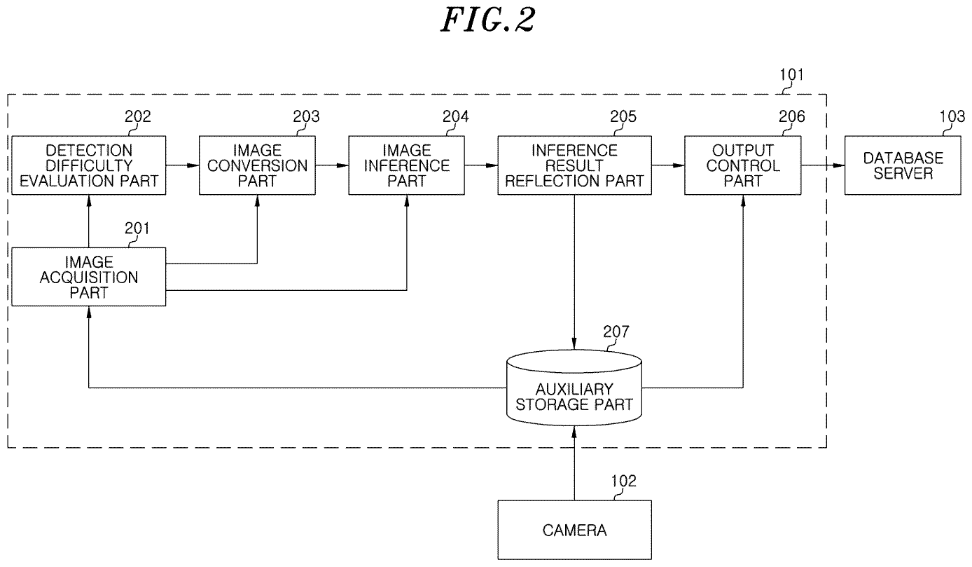

Next, the functional blocks of the analysis server 101 will be described with reference to FIG. 2. The analysis server 101 includes an image acquisition part 201, a detection difficulty evaluation part 202, an image conversion part 203, an image inference part 305, an inference result reflection part 205, an output control part 206, and an auxiliary storage part 207.

When the analysis server 101 receives an image captured by the camera 102, the image is stored in the auxiliary storage part 207. The image acquisition part 201 acquires an input image, as an image to be analyzed, from the auxiliary storage part 207. In doing so, the image acquisition part 201 may convert the image into any data format such as RGB color, YUV, or monochrome depending on the purpose of the image. In addition, the image acquisition part 201 may further perform a process of reducing the image to a predetermined size in order to reduce the processing cost in subsequent processing. The image to be analyzed may be all frame images received from the camera 102, or only frame images at regular intervals.

Here, if there is an image conversion method identified for the preprocessing by the inference result reflection part 205 to be described later, the image acquisition part 201 performs the image conversion as preprocessing on the input image acquired as described above. Then, the image acquisition part 201 outputs the preprocessed input image to the detection difficulty evaluation part 202 and the image inference part 204, and outputs the original input image, that has not been subjected to the preprocessing, to the image conversion part 203. On the other hand, if no image conversion method is designated for preprocessing, the image acquisition part 201 outputs the original input image to the detection difficulty evaluation part 202, the image conversion part 203, and the image inference part 204.

The detection difficulty evaluation part 202 calculates the difficulty of the object detection by the object detection AI model for the original or preprocessed input image acquired from the image acquisition part 201, and compares the calculated difficulty with a predetermined difficulty threshold. The difficulty level is a statistical measure that indicates the difficulty in detecting a detection target from an input image. The difficulty level is expressed as a numerical value ranging from 0 to 1, and 0.5 is used as the difficulty threshold, for example. If the difficulty level is higher than or equal to the difficulty threshold, it is evaluated that the difficulty level of the object detection from the input image is high (in other words, the accuracy of the object detection AI model for the input image is low). On the other hand, if the difficulty level is lower than the difficulty threshold, it is evaluated that the difficulty level of the object detection from the input image is not low (in other words, the accuracy of the object detection AI model for the input image is high). The detection difficulty evaluation part 202 outputs the result of the evaluation to the image conversion part 203. Any method such as a method using a detection difficulty evaluation AI model to be described later, or a method using background difference from a reference image can be used to calculate the difficulty level of the object detection.

The image conversion part 203 performs the image conversion on the original input image acquired from the image acquisition part 201 according to the output of the detection difficulty evaluation part 202. The image conversion part 203 performs the image conversion only when the detection difficulty evaluation part 202 evaluates that the difficulty level of the object detection from the input image is high. The image conversion part 203 deals with multiple types of image conversion methods, such as left-right inversion/horizontal flipping, luminance adjustment, contrast adjustment, noise removal, sharpening, and the like. The image conversion part 203 perform the image conversion by sequentially selecting, one by one, the image conversion methods different from the preprocessing image conversion method, and sequentially outputs the input image after the image conversion to the image inference part 204.

The image inference part 204 provides the original or preprocessed input image, acquired from the image acquisition part 201, to the object detection AI model to perform inference related to the object detection. As a result, the inference result including the position and certainty/confidence score of the candidate (hereinafter, referred to as “detection candidate”) of the detection target in the input image can be acquired as the output of the object detection AI model. The certainty is a statistical measure that indicates a degree of confidence of the inference, and is compared with a predetermined certainty threshold to be described later. The certainty is expressed as a numerical value in the range of 0% to 100%, and 50% is used as the certainty threshold, for example.

The image inference part 204 sequentially provides the converted input images acquired from the image conversion part 203 to the object detection AI model to perform inference related to the object detection. Since multiple types of converted input images are outputted from the image conversion part 203, the second inference is performed multiple times. The image inference part 204 outputs the inference result, acquired for each input image from the image acquisition part 201 or the image conversion part 203, to the inference result reflection part 205. Hereinafter, the original or preprocessed input image may be referred to as “input image before the image conversion.” In addition, the inference result related to the input image before the image conversion may be referred to as “first inference result,” and the inference result related to the input image after the image conversion may be referred to as “second inference result.”

The inference result reflection part 205 integrates the first inference result and the second inference result acquired from the image inference part 204, and outputs the integrated result, as a final inference result, to the output control part 206. In general, first, the inference result reflection part 205 determines, as the detection object, the object with the certainty greater than or equal to the certainty threshold among the detection object candidates in the first inference result. The inference result reflection part 205 determines whether or not to add the detection object candidate with the certainty less than the certainty threshold in the first inference result to a new detection object, depending on the certainty of the corresponding detection object candidate in the second inference result. Thereafter, the inference result reflection part 205 generates and outputs the final inference result including information (position and degree of certainty) on each detection object. In addition, the inference result reflection part 205 resets detection parameters, such as the image conversion method of preprocessing or the certainty threshold, depending on the presence/absence of the detection object candidate that has been newly added to the detection object, and outputs the setting data to the auxiliary storage part 207 for storage therein.

The output control part 206 transmits the final inference result acquired from the inference result reflection part 205 or the data such as the input image stored in the auxiliary storage part 207 to the database server 103 to be stored therein. Further, the output control part 206 may transmit the final inference result acquired from the inference result reflection part 205 or the data such as the input image stored in the auxiliary storage part 207 to a monitoring terminal (not shown) to be displayed thereon.

The auxiliary storage part 207 stores the programs executed by the analysis server 101, or the data to be processed by the programs. The auxiliary storage part 207 generally includes a non-volatile memory such as a hard disk drive (HDD) or a flash memory.

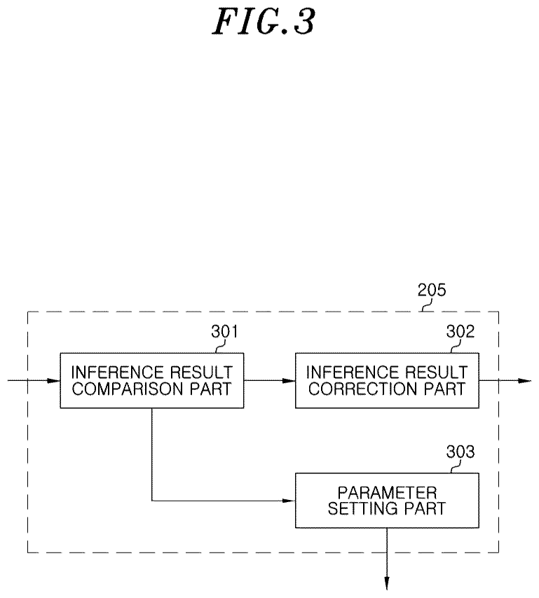

Next, the functional blocks of the inference result reflection part 205 will be described with reference to FIG. 3. Here, only the case where the detection difficulty evaluation part 202 evaluates that the difficulty of the object detection from the input image is high will be described, and the description of the case where the detection difficulty evaluation part 202 evaluates that the difficulty of the object detection from the input image is not high will be omitted.

The inference result reflection part 205 has an inference result comparison part 301, an inference result correction part 302, and a parameter setting part 303. The inference result reflection part 205 receives a first inference result corresponding to the input image before the image conversion and a second inference result corresponding to the input image after the image conversion. These inference results include information such as a candidate region (e.g., a rectangular region) indicating the position of the detection object candidate in each image and the certainty thereof.

The inference result comparison part 301 compares the first inference result with the second inference result to determine whether or not there is a detection object candidate to be newly added to the detection object. Specifically, the inference result comparison part 301 compares the region of the detection object candidate with the certainty less than the certainty threshold in the input image before the image conversion, with the region of the detection object candidate with the certainty greater than or equal to the certainty threshold in the input image after the image conversion. As a result, if there exists a detection object candidate with a high degree of overlap between the two regions, the inference result comparison part 301 newly adds the detection object candidate to the detection object.

The inference result correction part 302 corrects the first inference result based on the position information of the detection object newly added by the inference result comparison part 301, and outputs the corrected result as the final inference result. Specifically, the inference result correction part 302 outputs, as the final inference result, a rectangular frame indicating the detection object added in consideration of the second inference result, which is drawn on the input image before the image conversion, for example, as well as a rectangular frame indicating the detection object determined from the first inference result to the output control part 206. Further, the symbol indicating the detection object is not limited to the rectangular frame described above, and other symbols such as an arrow and the like may be used.

The parameter setting part 303 identifies an image conversion method that yields the highest average certainty of the detection object candidates, based on the comparison result by the inference result comparison part 301, and sets it as the image conversion method for preprocessing in the subsequent operations. In addition, the parameter setting part 303 sets the lowest certainty among the certainties of the final detection object as the certainty threshold for the subsequent operations. The parameter setting part 303 outputs the setting data of the detection parameters to the auxiliary storage part 207 for storage, so that the detection parameters can be applied to the subsequent operations.

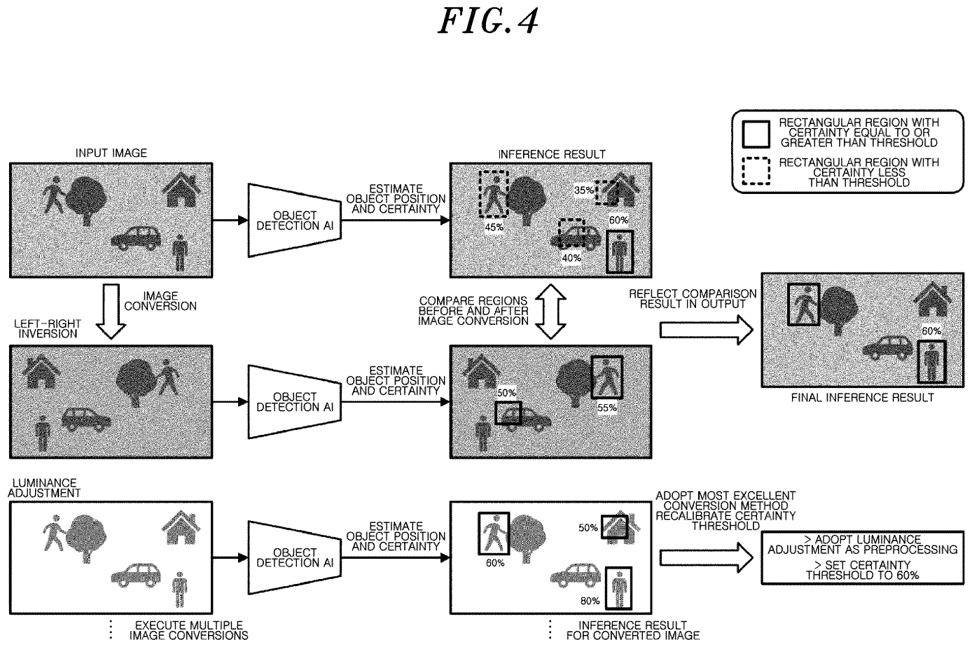

Next, an overview of the comparison of image conversion methods in this system will be described with reference to FIG. 4. Here, a case where a person is detected as a detection target will be described as an example. First, as shown in FIG. 4, when the detection difficulty evaluation part 202 evaluates that the difficulty of the object detection is high for the input image before the image conversion, which is acquired from the image acquisition part 201, the image conversion part 203 sequentially selects multiple types of image conversion methods one by one, which are different from the preprocessing, and executes the selected method.

Next, the image inference part 204 provides the input image before the image conversion, acquired from the image acquisition part 201, to the object detection AI model to perform inference. Further, the image inference part 204 provides the input images after the image conversion acquired from the image conversion part 203 to the object detection AI model to perform inference. In the example of FIG. 4, as the first inference result for the input image before the image conversion, one person candidate (indicated by a solid rectangular region) with the certainty greater than or equal to the certainty threshold (50% in this example) and three person candidates (indicated by dashed rectangular regions) with the certainty less than the certainty threshold are detected. In addition, as the second inference result for the input image subjected to the left-right conversion, two person candidates with the certainty greater than or equal to or the certainty threshold are detected, and as the second inference result for the input image subjected to the luminance adjustment, three person candidates with the certainty greater than or equal to the certainty threshold are detected.

Next, the inference result reflection part 205 integrates the inference results of the respective images by the image inference part 204. Specifically, the person candidate with the certainty greater than or equal to the certainty threshold in the first inference result is determined as the detection object, and the regions of the other person candidates are compared with the region of the person candidate with the certainty greater than or equal to the certainty threshold in the second inference result to determine whether or not they can be newly added to the detection objects. Here, in order to reduce the processing load, the top-k regions (i.e., the k-number of regions with the highest certainty) are compared, instead of all the regions of the person candidates with the certainty less than the certainty threshold in the first inference result.

As a result, if there is no person candidate that can newly added to the detection objects, the inference result reflection part 205 generates the final inference result that reflects only the detection object determined from the first inference result. On the other hand, if there is a person candidate that can be newly added to the detection objects, the inference result reflection part 205 generates the final inference result in which the person candidate is added to the detection objects. In the example of FIG. 4, only one person candidate (the person on the right side in the image) was determined as the detection object from the input image before the image conversion, but one new person candidate (the person on the left side in the image) was added to the detection objects by comparison with the inference result of the input image after the image conversion, and reflected in the final inference result.

The inference result reflection part 205 calculates the average certainty of the person candidates for each input image after the image conversion, and sets the image conversion method that yields the highest average certainty as the image conversion method for preprocessing in the subsequent operations. In the example of FIG. 4, the luminance adjustment is set as the preprocessing for the subsequent operations. In addition, in order to suppress erroneous detection in which an object other than the detection target is detected as the detection object, the inference result reflection part 205 sets the lowest certainty among the certainties of the final detection object as the certainty threshold in the subsequent operations. In the example of FIGS. 4, 60% is set as the certainty threshold in the subsequent operations.

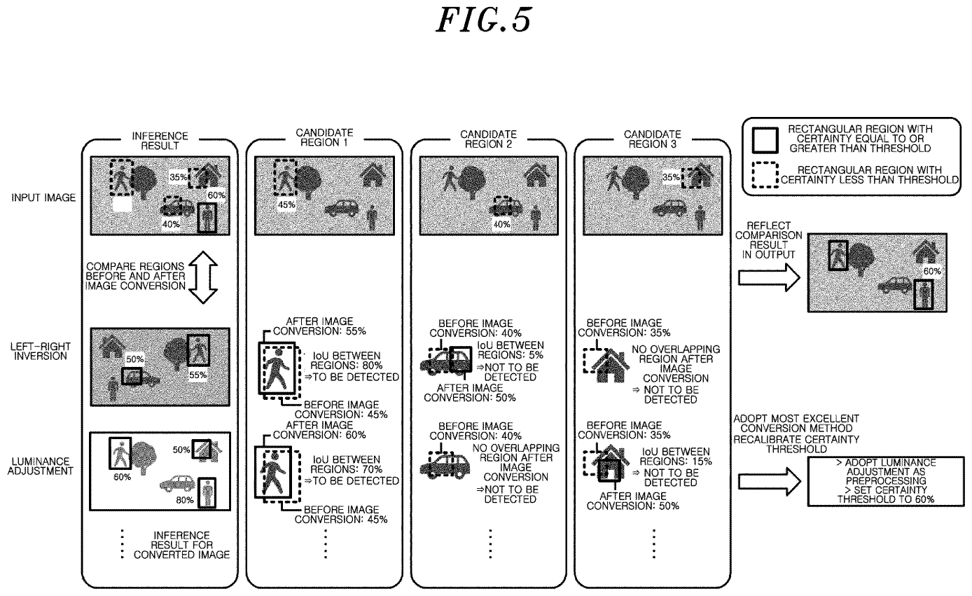

Next, a method using intersection over union (IoU: overlap ratio/degree between regions) will be described with reference to FIG. 5 as an example of a method for comparing inference results before and after the image conversion by the inference result reflection part 205. Here, the IoU between the top-3 regions of the person candidates with the certainty less than the certainty threshold (for example, 50%) in the input image before the image conversion and the region of the person candidate with the certainty greater than or equal to the certainty threshold in the input image after the image conversion is calculated. In the example of FIG. 5, the region showing the person candidate with the certainty of 45% (the person on the left side in the image) in the input image before the image conversion is set as “candidate region 1,” the region showing the person candidate with the certainty of 40% (actually a part of a car) is set as “candidate region 2,” and the region showing the person candidate with the certainty of 35% (actually a part of a house) is set as “candidate region 3.”

Here, if there exists a region where the IoU between corresponding areas before and after the image conversion is greater than or equal to a predetermined IoU threshold (e.g., 50%), the person candidate in the region is newly added to the detection object. For example, in the case of comparing the input images before and after the luminance adjustment, the IoU between the corresponding regions before and after the conversion is 70%, and the regions overlap significantly, so that the candidate region 1 is newly added to the detection object. On the other hand, the candidate region 2 is not added to the detection object because there is no corresponding region before and after the conversion, i.e., because the IoU is 0%. Further, the candidate region 3 is not added to the detection object because the IoU between the corresponding regions before and after the conversion is 15%, which is low, and the regions overlap very slightly.

In addition, in order to suppress erroneous detection in which an object other than the detection target is newly added to the detection object, ensemble may be performed on the second inference results for the multiple input images after the image conversion. Specifically, when ten second inference results are acquired for ten input images after the image conversion, for example, the object in the corresponding region may be added to the detection object only when the IoU between the corresponding regions before and after the conversion is greater than or equal to the IoU threshold in five (more than half) of the second inference results.

Further, as the modification of the ensemble, the detection object may be added by the ensemble of multiple second inference results, regardless of whether or not the region corresponds to the candidate region detected from the input image before the image conversion. For example, the multiple second inference results may be compared with each other to calculate the IoU between the regions with the certainty greater than or equal to the certainty threshold, and if the region with the IoU greater than or equal to the IoU threshold is found, the object in the region may be added to the detection object. For another example, when the number of combinations of the second inference results in which the region where the above condition is satisfied is greater than or equal to a certain percentage (e.g., 70%) of the total number of combinations, the object in the region may be added to the detection object. Further, the certainty threshold or the IoU threshold used in this case may be the same as the thresholds used in the processing of the input image before the image conversion, or may be values different from them (for example, stricter values).

When a new detection object is added by the comparison, the inference result reflection part 205 generates the final inference result in which the detection object is also reflected. The inference result reflection part 205 calculates the average certainty of the person candidates for each input image after the image conversion, and sets the image conversion method that ensures the highest average certainty (luminance adjustment in the example of FIG. 5) as the image conversion method for the preprocessing in the subsequent operations. In addition, the inference result reflection part 205 sets the lowest certainty (60% in the example of FIG. 5) among the certainties of the final detection object as the certainty threshold in the subsequent operations.

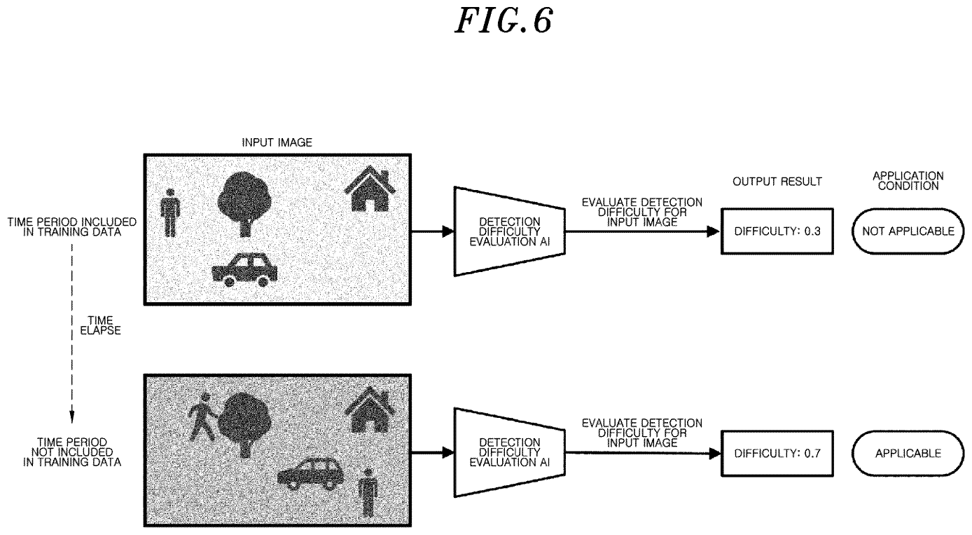

Next, the case in which the detection difficulty evaluation AI model is used to evaluate the difficulty in detecting the detection target from the input image before the image conversion (i.e., the processing of the detection difficulty evaluation part 202) will be described with reference to FIG. 6. The AI model disclosed in Non-Patent Document 2 can be used as the detection difficulty evaluation AI model, for example. As shown in FIG. 6, the detection difficulty evaluation part 202 provides the input image before the image conversion to the detection difficulty evaluation AI model to calculate the difficulty of the object detection. Then, when the difficulty of the object detection is greater than a predetermined difficulty threshold (e.g., 0.5), the detection difficulty evaluation AI model is set to execute (apply) the above-described series of processes (i.e., image conversion of the input image, inference related to the input image after the image conversion, integration of the inference results, update of the detection parameters, and the like).

The detection difficulty evaluation AI model is a model that has trained the degree of difference (loss) between the inference result of the object detection AI model and the correct answer. In general, if the input image is similar to the training data, the difficulty is calculated to be low, and if the input image is not similar to the training data, the difficulty is calculated to be high. Therefore, it is possible to efficiently determine whether or not to execute the above-described series of processes for an object detection task in an outdoor imaging environment where the appearance of an object changes depending on time of day (e.g., day/night) and season, or for an object detection task in an untrained imaging location. In FIG. 6, the input image itself is inputted to the detection difficulty evaluation AI model. However, the input to the detection difficulty evaluation AI model is not limited thereto. For example, the output result of the intermediate layer in the case of performing the inference related to the input image in the object detection AI model may be inputted to the detection difficulty evaluation AI model.

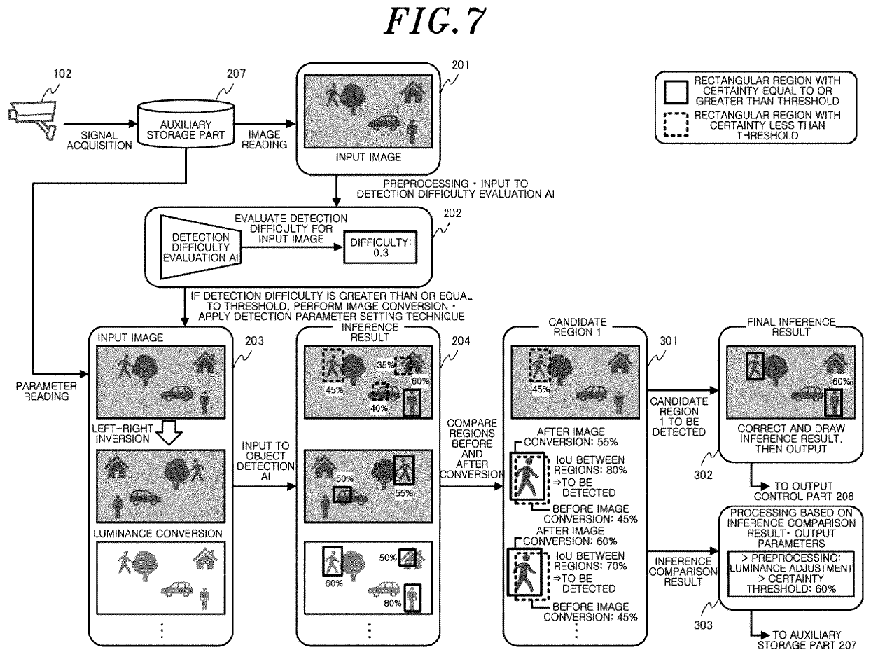

Next, the overall flow of the operation of the monitoring system shown in FIG. 1 will be described with reference to FIG. 7. The auxiliary storage part 207 stores images transmitted from the camera 102. First, the image acquisition part 201 acquires an input image to be analyzed from the auxiliary storage part 207. In this case, if the image conversion method for the preprocessing has been set by the parameter setting part 303 in advance, the image conversion method for the preprocessing is performed on the original input image.

Next, the detection difficulty evaluation part 202 calculates the difficulty of the object detection by the object detection AI model for the input image acquired from the image acquisition part 201 using the detection difficulty evaluation AI model, and compares it with a predetermined difficulty threshold. As a result, if the difficulty of the object detection is less than the difficulty threshold, the image conversion part 203 does not perform the image conversion. In other words, the image inference part 204 performs the inference by providing the input image before the image conversion, which is acquired from the image acquisition part 201, to the object detection AI model, and outputs the acquired first inference result to the output control part 206 without correction by the inference result correction part 302.

On the other hand, if the difficulty of the object detection is greater than or equal to the difficulty threshold, the image conversion part 203 performs the image conversion different from the preprocessing on the input image acquired from the image acquisition part 201. Next, the image inference part 204 performs the inference by providing both the input image before the image conversion and the input image after the image conversion to the object detection AI model, and acquires the first inference result and the second inference result. Next, the inference result comparison part 301 calculates the IoU between the region with the certainty less than the certainty threshold in the first inference result and the region with the certainty greater than or equal to the certainty threshold in the second inference result. If the IoU is greater than or equal to the IoU threshold, the corresponding detection object candidate is added as a new detection object. Next, the inference result correction part 302 corrects the first inference result based on the position information of the new detection object, and outputs it as the final inference result to the output control part 206. In addition, the parameter setting part 303 sets the image conversion method that yields the highest average certainty of the detection object candidate as the image conversion method for the preprocessing in the subsequent operations. Further, the lowest certainty among the certainties of the final detection object is set as the certainty threshold in the subsequent operations.

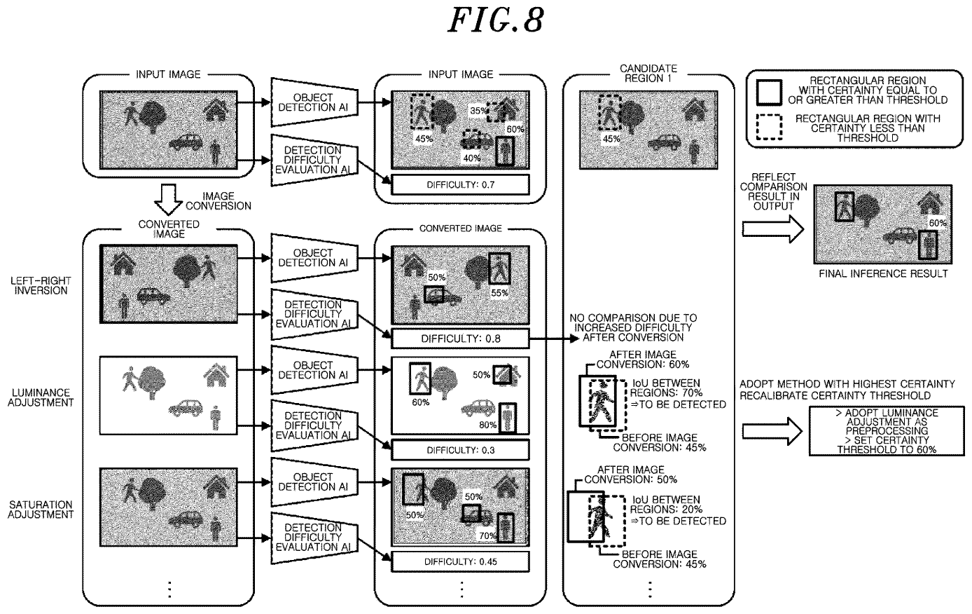

In the above description, the presence or absence of an object that can be added to the new detection object is determined based on the IoU between the regions. However, the determination may be made by using the detection difficulty evaluation AI model as well as the IoU. The detection object determination method using both the IoU between the regions and the detection difficulty evaluation AI model will be described with reference to FIG. 8.

In the example of FIG. 8, the inference result reflection part 205 provides the input image before the image conversion and the input image after the image conversion to the detection difficulty evaluation AI model, and calculates the difficulty of the object detection for each image. Then, when the difficulty of the object detection after the image conversion is lower than the difficulty of the object detection before the image conversion, the IoU with the candidate region with the certainty greater than or equal to the certainty threshold in the second inference result is calculated for the top-1 region with the certainty less than the certainty threshold in the first inference result.

For example, in the input image after the image conversion by the luminance adjustment, the difficulty (=0.3) of the object detection is lower than the difficulty (=0.7) before the image conversion, and the IoU between the regions before and after the conversion is greater than or equal to the IoU threshold. Therefore, a new detection object can be added by comparing the first inference result with the second inference result related to the conversion image after the luminance adjustment. On the other hand, in the input image after the image conversion by the left-right inversion, the difficulty (=0.8) of the object detection is greater than that before the image conversion, so that the comparison between the regions before and after the conversion is not performed. Further, in the input image after the image conversion by the saturation adjustment, the difficulty (=0.45) of the object detection is less than that before the image conversion, but the IoU between the regions before and after the conversion is less than the IoU threshold. Therefore, there is no addition of a new detection object by the comparison between the first inference result and the second inference result related to the input image after the left-right inversion or the saturation adjustment. In this manner, by using the detection difficulty evaluation AI model, it is possible to easily identify the image conversion method suitable for the object detection. Since the candidate region acquired from the input image subjected to the image conversion is highly likely to indicate the detection target, it is possible to suppress erroneous detection of objects other than the detection target.

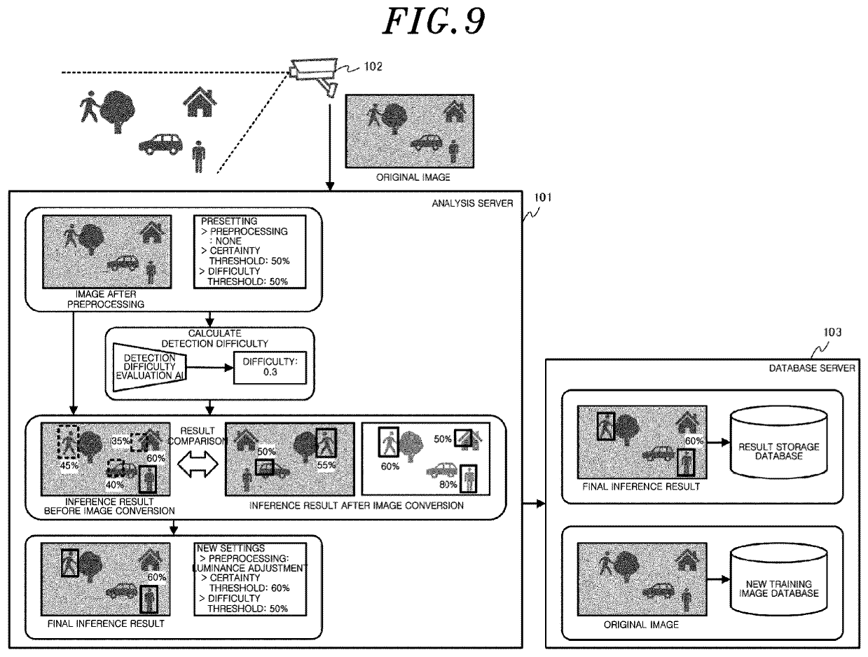

Next, the addition of the training data to the object detection AI model due to the addition of a new detection object will be described with reference to FIG. 9. The image acquired by the camera 102 is transmitted to the analysis server 101. The analysis server 101 performs the image conversion as the preprocessing on the original input image, based on the setting of the detection parameters, calculates the difficulty of the object detection, and determines whether or not the image conversion different from the preprocessing is required. If it is determined that the image conversion different from the preprocessing is required, the analysis server 101 performs the image conversion on the input image, compares the inference results before and after the conversion, and outputs a final inference result in which the result is reflected.

When there is an object that is newly added to the detection objects by comparing the inference results before and after the conversion, the analysis server 101 resets the threshold values or the image conversion method for the preprocessing to be applied to the processing of subsequent frames, and transmits the final inference result and the original input image to the database server 103. The final inference result and the original input image transmitted to the database server 103 are stored in a result storage database and new training database, respectively. The database server 103 uses the original input image stored in the new learning database for re-training, and updates the object detection AI model or the detection difficulty evaluation AI model. Accordingly, it is possible to further improve the accuracy of the inference related to the object detection.

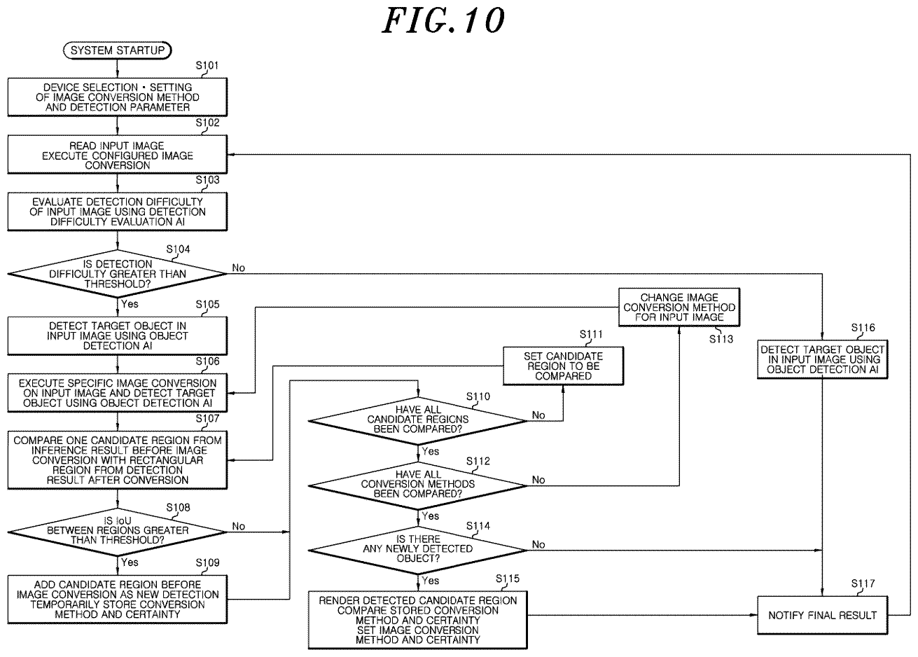

FIG. 10 shows an example of the processing flow of the monitoring system shown in FIG. 1. First, the analysis server 101 executes the program loaded from the auxiliary storage part 207 to the main storage part by the processor to start the image analysis system, and executes the processing of steps S101 to S117 to be described later. The image analysis system may allow a user to check the processing results and the related information in detail on a graphical user interface (GUI), or may notify a user of the presence or absence of the detection object.

After the image analysis system is started, in step S101, the analysis server 101 determines the detection parameters such as the camera for acquiring the input image, the frequency at which the input image is acquired, the size of the input image, the AI model to be used, the image conversion method for the preprocessing, the threshold value to be used, and the like. These detection parameters may be set by reading a setting file prepared in advance, or may be selected by the user on the GUI. The number of cameras for acquiring the input image may be one or multiple. In the following description, an example in which one camera acquires an input image and an image of a monitoring region is acquired in real time will be described.

In step S102, the image acquisition part 201 reads the input image acquired from the camera as an analysis target. Further, the image acquisition part 201 performs the image conversion as the preprocessing image on the input image according to the image conversion method for the preprocessing that is set in step S101 (or the image conversion method set as the preprocessing in the previous frame).

In step S103, the detection difficulty evaluation part 202 calculates the difficulty in detecting the detection target from the input image using the detection difficulty evaluation AI model.

In step S104, the detection difficulty evaluation part 202 determines whether the difficulty of the object detection calculated in step S103 is greater than or equal to the difficulty threshold determined in step S101 (step S104). As a result, if the condition is satisfied (i.e., the difficulty of the object detection is greater than or equal to the difficulty threshold), the processing proceeds to step S105. Otherwise, the processing proceeds to step S116.

In step S105, the image inference part 204 performs the detection of the detection target using the object detection AI model for the input image acquired in step S102, and acquires the first inference result.

In step S106, the image conversion part 203 performs the image conversion on the input image acquired in step S102 using one selected from multiple types of image conversion methods different from the preprocessing. The image inference part 204 performs the detection of the detection target using the object detection AI model for the input image after the image conversion acquired in the image conversion part 203, and acquires the second inference result.

In step S107, the inference result comparison part 301 compares one of the candidate regions with the certainty less than the certainty threshold in the first inference result acquired in step S105 with the candidate region with the certainty greater than or equal to the certainty threshold in the second inference result acquired in step S106, and calculates the IoU between the regions.

In step S108, the inference result comparison part 301 determines whether the IoU between the regions acquired in step S107 is greater than or equal to the IoU threshold determined in step S101. If the condition is satisfied (i.e., the IoU is greater than or equal to the IoU threshold), the processing proceeds to step S109. Otherwise, the processing proceeds to step S110.

In step S109, the inference result comparison part 301 determines the object in the candidate region of the first inference result compared in step S107 as a new detection object, and temporarily stores the image conversion method selected in step S106 and the certainty of the candidate region in the input image after the image conversion that is determined to satisfy the condition in step S108.

In step S110, the inference result comparison part 301 determines whether or not the comparison has been completed for all the candidate regions with the certainty less than the certainty threshold in the first inference result acquired in step S105. If the condition is satisfied (i.e., if the comparison has been completed for all the candidate regions), the processing proceeds to step S112. Otherwise, the processing proceeds to step S111.

In step S111, the inference result comparison part 301 changes the candidate region to be compared in step S107.

In step S112, the inference result comparison part 301 determines whether or not the comparison of the candidate region has been completed using all image conversion methods different from the preprocessing. If the condition is satisfied (i.e., if the comparison of the candidate region has been completed using all image conversion methods), the processing proceeds to step S114. Otherwise, the processing proceeds to step S113.

In step S113, the image conversion part 203 changes the image conversion method used for the image conversion of the input image in step S106.

In step S114, the inference result correction part 302 determines whether or not a candidate region that has become a new detection object in step S109 exists. If the condition is satisfied (i.e., if a candidate region that has become a new detection object exists), the processing proceeds to step S115. Otherwise the processing proceeds to step S117.

In step S115, the inference result correction part 302 corrects the first inference result using the position information of the candidate region that has become a new detection object in step S109. In addition, the parameter setting part 303 compares the image conversion method and the certainty of the region in the input image after the image conversion stored in step S109. Then, the image conversion method that ensures the highest average certainty of the region in the input image after the image conversion is set as the preprocessing to be applied in the subsequent frames. In addition, the lowest certainty of the final detection object is set as the certainty threshold to be applied in the subsequent frames.

In step S116, the image inference part 204 detects the detection target using the object detection AI model for the input image acquired in step S102.

In step S117, the output control part 206 notifies a user of the final inference result. Here, the final result can be notified by any appropriate method. For example, the final result may be displayed on the GUI, or the notification indicating that the detection target has been detected may be transmitted to a small terminal. When the notification of the final result is completed, the processing returns to step S102, and the image acquisition part 201 acquires a next image to be analyzed. The processing flow described with reference to FIG. 10 is merely an example, and is not limited thereto.

As described above, the analysis server 101 in the monitoring system of this example is configured as follows: the image acquisition part 201 acquire an original input image received from the camera 102 and the image conversion as the preprocessing is performed on the original input image when the image conversion as the preprocessing is set; the image conversion part 203 perform the image conversion different from the preprocessing on the original input image; the image inference part 204 provide the input image before the image conversion by the image conversion part 203 (the original or preprocessed input image) to the object detection AI model to acquire the first inference result, and provides the input image after the image conversion by the image conversion part 203 to the object detection AI model to acquire the second inference result; and the inference result reflection part 205 integrate the second inference result with the first inference result to acquire the final inference result. In other words, even if the accuracy of the first inference result based on the original input image (the original or preprocessed input image) is low, the decrease in accuracy of the first inference result can be compensated for by integrating it with the second inference result based on the input image after various types of image conversion. Therefore, it is possible to effectively suppress the influence of the decrease in the inference accuracy of the object detection AI model.

In addition, the analysis server 101 is configured as follows: the detection difficulty evaluation part 202 calculates the difficulty of the object detection related to the input image before the image conversion by the image conversion part 203 and compares it with the difficulty threshold; the image conversion part 203 performs the image conversion different from the preprocessing on the original input image when the difficulty of the object detection is greater than or equal to the difficulty threshold; the image inference part 204 provides the input image after the image conversion by the image conversion part 203 to the object detection AI model to acquire the second inference result; and the inference result reflection part 205 executes a series of processes for integrating the second inference result with the first inference result and does not execute this series of processes is not executed when the difficulty of the object detection is less than the difficulty threshold. In other words, only when the decrease in accuracy of the first inference result based on the original input image (original or preprocessed input image) is expected, the inference related to the input image after various types of image conversion or the process of integrating the results is performed. Therefore, the increase in the processing load can be effectively suppressed.

Further, the analysis server 101 is configured as follows: the image conversion part 203 performs multiple types of image conversions, which are different from the preprocessing, on the input image; the image inference part 204 provides the input image after the multiple types of image conversion to the object detection AI model to acquire a plurality of second inference results; and the parameter setting part 303 sets the image conversion corresponding to the inference result that provides the best result among the plurality of second inference results as the preprocessing in the subsequent processes. Thus, it is possible to automatically set an image conversion method in which the inference result with high accuracy is obtained according to the change in the operating environment (for example, a change in time of day or season).

Further, the analysis server 101 is configured as follows: the inference result reflection part 205 determines whether or not to integrate the second inference result with the first inference result based on the degree of overlap between the region of the detection object candidate in the first inference result and the region of the detection object candidate in the second inference result. More specifically, the IoU indicating the degree of overlap between the region of the detection object candidate with the certainty less than the certainty threshold in the input image before the image conversion and the region of the detection object candidate with the certainty greater than or equal to the certainty threshold in the input image after the image conversion is calculated and compared with the IoU threshold, and the detection object candidate with the IoU greater than or equal to the IoU threshold is added, as a new detection object, to the first inference result. Hence, it is possible to determine whether or not to add the detection object candidate with the low certainty in the first inference result to the new detection object based on the second inference result.

Further, as described as the modification, the analysis server 101 may be configured such that the inference result reflecting part 205 determines whether or not to integrate the second inference result with the first inference result based on the degree of overlap between the regions of the detection object candidates among the multiple second inference results corresponding to the multiple types of image conversion. In other words, it is possible to determine whether or not to add an object that has not become a detection object candidate in the first inference result to the new detection object while collectively considering the multiple second inference results.

While the embodiments of the present disclosure have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

Further, the present disclosure can be provided as the above-described apparatus or the system including the apparatus, and can also be provided as a method executed by the apparatus, a program for realizing the function of the apparatus by the processor, and a recording medium that records the program to be readable by the computer.

### INDUSTRIAL APPLICABILITY

The present disclosure can be used in an image analysis system that performs object detection processing for detecting a predetermined object from an input image using an AI model.

### DESCRIPTION OF REFERENCE NUMERALS

101: analysis server, 102: camera, 103: database server, 104: network, 201: image acquisition part, 202: detection difficulty evaluation part, 203: image conversion part, 204: image inference part, 205: inference result reflection part, 206: output control part, 207: auxiliary storage part, 301: inference result comparison part, 302: inference result correction part, 303: parameter setting part

1. An image analysis system for detecting an object from an input image by inference using an AI model, the image analysis system comprising an analysis server comprising:
a function for acquiring a first conversion image by performing a first image conversion, which is set as preprocessing, on the input image;
a function for acquiring a second conversion image by performing a second image conversion, which is different from the first image conversion, on the input image;
a function for acquiring a first inference result by providing the input image or the first conversion image to the AI model;
a function for acquiring a second inference result by providing the second conversion image to the AI model;
a function for integrating the second inference result with the first inference result; and
a function for calculating a difficulty in detecting the object from the input image or the first conversion image to compare with a first threshold,
wherein if the difficulty is equal to or greater than the first threshold, the analysis server performs a series of processes for acquiring the second conversion image by performing the second image conversion on the input image, acquiring the second inference result by providing the second conversion image to the AI model, and integrating the second inference result with the first inference result, and otherwise, the analysis server does not perform the series of processes.

2. The image analysis system of claim 1,
wherein the inference result includes a candidate region of the object in the image provided to the AI model, and
whether or not to integrate the second inference result with the first inference result is determined based on a degree of overlap between a candidate region of the object in the first inference result and a candidate region of the object in the second inference result.

3. An image analysis system for detecting an object from an input image by inference using an AI model, the image analysis system comprising:
a function for acquiring a first conversion image by performing a first image conversion, which is set as preprocessing, on the input image;
a function for acquiring a second conversion image by performing a second image conversion, which is different from the first image conversion, on the input image;
a function for acquiring a first inference result by providing the input image or the first conversion image to the AI model;
a function for acquiring a second inference result by providing the second conversion image to the AI model; and
a function for integrating the second inference result with the first inference result, wherein the second image conversion includes multiple types of image conversion, and
an image conversion corresponding to an inference result that provides a best result among a plurality of inference results respectively corresponding to the multiple types of image conversion is set as preprocessing for subsequent processes.

4. The image analysis system of claim 3, wherein the inference result includes a candidate region of the object in the image provided to the AI model, and
whether or not to integrate the second inference result with the first inference result is determined based on a degree of overlap between a candidate region of the object in the first inference result and a candidate region of the object in the second inference result.

5. An image analysis system for detecting an object from an input image by inference using an AI model, the image analysis system comprising:
a function for acquiring a first conversion image by performing a first image conversion, which is set as preprocessing, on the input image;
a function for acquiring a second conversion image by performing a second image conversion, which is different from the first image conversion, on the input image;
a function for acquiring a first inference result by providing the input image or the first conversion image to the AI model;
a function for acquiring a second inference result by providing the second conversion image to the AI model; and
a function for integrating the second inference result with the first inference result, wherein the second image conversion includes multiple types of image conversion,
the inference result includes a candidate region of the object in the image provided to the AI model, and
whether or not to integrate the second inference result with the first inference result is determined based on a degree of overlap between a candidate regions of the object in multiple inference results respectively corresponding to the multiple types of image conversion.

6. The image analysis system of claim 5, wherein whether or not to integrate the second inference result with the first inference result is determined based on a degree of overlap between a candidate region of the object in the first inference result and a candidate region of the object in the second inference result.
